(19) United States
(12) Patent Application Publication
(10) Pub. No.: US 2013/0258729 A1
(43) Pub. Date: Oct. 3, 2013

(54) MEDIUM VOLTAGE POWER APPARATUS

(71) Applicant: PETER BARBOSA, TAOYUAN HSIEN (TW)

(72) Inventor: PETER BARBOSA, TAOYUAN HSIEN (TW)

(73) Assignee: DELTA ELECTRONICS, INC., TAOYUAN HSIEN (TW)

(21) Appl. No.: 13/433,299

(22) Filed: Mar. 29, 2012

(51) Int. Cl. H02M 5/00

(52) U.S. Cl. 363/71

(57) ABSTRACT

A power apparatus includes power modules. Each of the power modules includes an input transformer and power cell units. The input transformer has at least one primary winding and a plurality of secondary windings, and the primary winding is electrically connected to an AC power source. The power cell units are connected in series with one phase output line to a multi-phase load, in which the power cell units are electrically connected to the secondary windings, respectively.

### BACKGROUND

1. Technical Field

The present disclosure relates to a power apparatus. More particularly, the present disclosure relates to a medium voltage power apparatus for a multi-phase load.

2. Description of Related Art

Variable frequency drives are conventionally used to provide variable electric speed for AC motors and also for other applications related to where a variable output voltage or frequency is desired. Typical drives have an AC input power source and a converter for converting an AC input voltage into a variable-voltage or variable-frequency output. FIG. 1 is a diagram illustrating a conventional drive. As shown in FIG. 1, the drive employs a number of connected power cells 12 through 20 to generate a three-phase AC output through phase output lines 22, 23, 24 for a three-phase AC motor 21, and three-phase input power is supplied to each of the power cells 12 through 20 by way of single one transformer 2 which is consisted of a primary winding and multiple secondary windings (e.g., 9 secondary windings).

However, under the condition of high power, the transformer 2 mentioned above becomes cumbersome and difficult to be cooled down such that the thermal management is uneasy. Moreover, the transformer 2 requires one primary winding and nine secondary windings, so the transformer configuration (particularly the windings) is too complex and inconvenient to be manufactured and also leads to higher cost of manufacturing, further increasing the overall price of the system.

### SUMMARY

An aspect of the present invention provides a power apparatus including a plurality of power modules. Each of the power modules includes an input transformer and a plurality of power cell units. The input transformer has at least one primary winding and a plurality of secondary windings, and the primary winding is electrically connected to an AC power source. The power cell units are connected in series with one phase output line to a multi-phase load, in which the power cell units are electrically connected to the secondary windings, respectively.

Another aspect of the present invention provides a power apparatus including a plurality of power modules. The power modules are configured for transforming a multi-phase input power into out-of-phase power outputs, respectively, to a multi-phase load. Each of the power modules includes an input transformer and a plurality of power cell units. The input transformer has at least one primary winding and a plurality of secondary windings. The primary winding is configured for receiving the multi-phase input power, and the secondary windings are configured for generating three-phase AC power outputs, respectively. The power cell units are connected in series with one phase output line to the multi-phase load, in which the power cell units are configured for converting the three-phase AC power outputs from the secondary windings into in-phase power outputs to the multi-phase load, respectively.

Yet another aspect of the present invention provides a power apparatus including a first input transformer, a plurality of first power cell units, a second input transformer, a plurality of second power cell units, a third input transformer, and a plurality of third power cell units. The first input transformer has at least one first primary winding and a plurality of first secondary windings, and the first primary winding is electrically connected to an AC power source. The first power cell units are connected in series with a first phase output line to a multi-phase load, in which the first power cell units are electrically connected to the first secondary windings, respectively. The second input transformer has at least one second primary winding and a plurality of second secondary windings, and the second primary winding is electrically connected to the AC power source. The second power cell units are connected in series with a second phase output line to the multi-phase load, in which the second power cell units are electrically connected to the second secondary windings, respectively. The third input transformer has at least one third primary winding and a plurality of third secondary windings, and the third primary winding is electrically connected to the AC power source. The third power cell units are connected in series with a third phase output line to the multi-phase load, in which the third power cell units are electrically connected to the third secondary windings, respectively.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference to the accompanying drawings as follows:

FIG. 1 is a diagram illustrating a conventional drive;

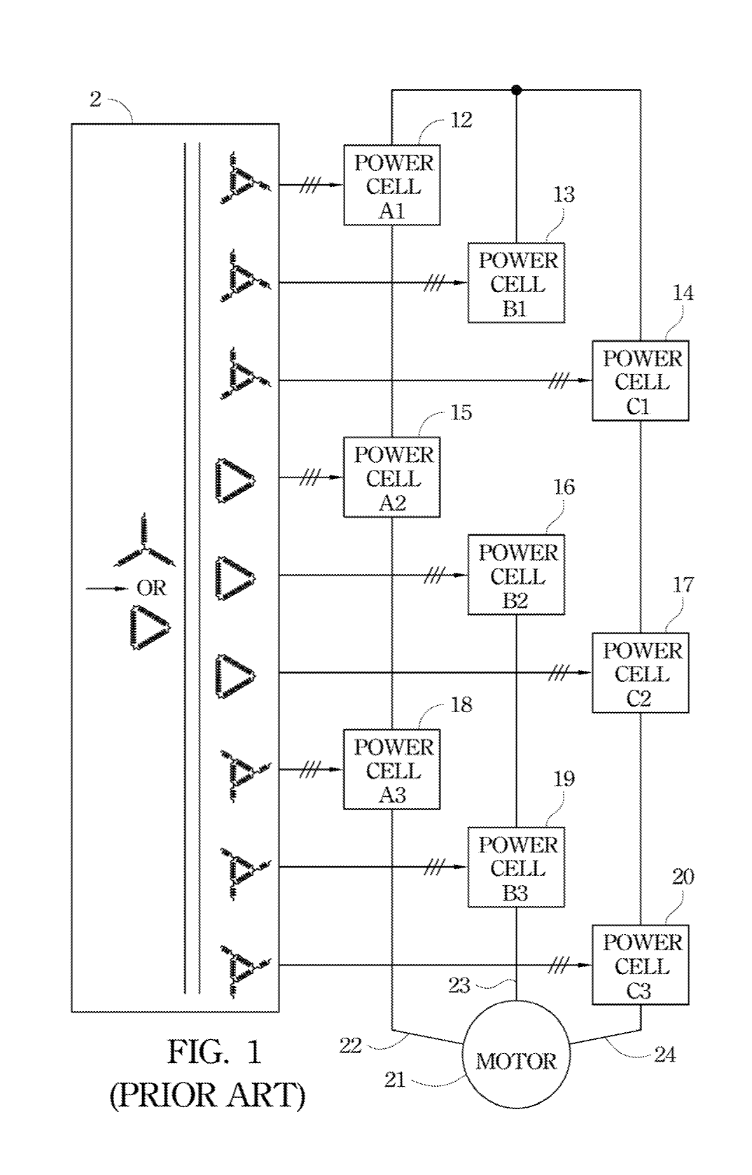

FIG. 2 is a diagram illustrating a power apparatus in accordance with one embodiment of the present invention;

FIG. 3 is a diagram illustrating a power apparatus in accordance with another embodiment of the present invention; and

FIG. 4 is a diagram illustrating the power apparatus shown in FIG. 3 in accordance with one embodiment of the present invention.

### DESCRIPTION OF THE EMBODIMENTS

In the following description, specific details are presented to provide a thorough understanding of the embodiments of the present invention. Persons of ordinary skill in the relevant art will recognize, however, that the present invention can be practiced without one or more of the specific details, or in combination with other components. Well-known implementations or operations are not shown or described in detail to avoid obscuring aspects of various embodiments of the present invention.

The terms used in this specification generally have their ordinary meanings in the art and in the specific context where each term is used. The use of examples anywhere in this specification, including examples of any terms discussed herein, is illustrative only, and in no way limits the scope and meaning of the invention or of any exemplified term. Likewise, the present invention is not limited to various embodiments given in this specification.

As used herein, the terms “comprising,” “including,” “having,” “containing,” “involving,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present invention. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may not be in direct contact with each other. “Coupled” may still be used to indicate that two or more elements cooperate or interact with each other.

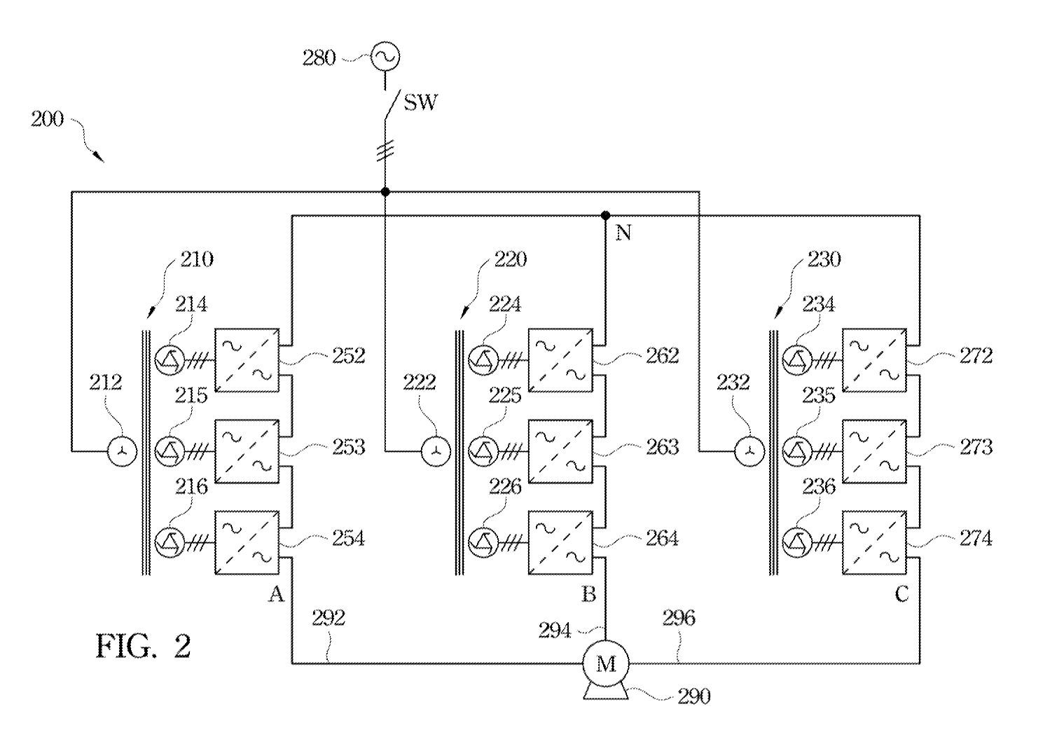

FIG. 2 is a diagram illustrating a power apparatus in accordance with one embodiment of the present invention. As shown in FIG. 2, the power apparatus 200 includes input transformers 210, 220, 230 and power cell units 252-254, 262-264, 272-274, in which the input transformer 210 is electrically connected to the power cell units 252-254, the input transformer 220 is electrically connected to the power cell units 262-264, and the input transformer 230 is electrically connected to the power cell units 272-274. In some embodiments, the input transformers 210, 220, 230 are individual, and they may be the same or different from one another.

The input transformer 210 has at least one primary winding 212 and secondary windings 214-216, and the primary winding 212 is electrically connected to an AC power source 280, for example, through a switch SW. The input transformer 220 has at least one primary winding 222 and secondary windings 224-226, and the primary winding 222 is electrically connected to the AC power source 280, for example, through the switch SW. Similarly, the input transformer 230 has at least one primary winding 232 and secondary windings 234-236, and the primary winding 232 is electrically connected to the AC power source 280, for example, through the switch SW.

The power cell units 252-254 are connected in series with a phase output line 292 to a multi-phase load (e.g., three-phase AC motor) 290, and the power cell units 252-254 are electrically connected to the secondary windings 214-216, respectively. The power cell units 262-264 are connected in series with a phase output line 294 to the multi-phase load 290, and the power cell units 262-264 are electrically connected to the secondary windings 224-226, respectively. Similarly, the power cell units 272-274 are connected in series with a phase output line 296 to the multi-phase load 290, and the power cell units 272-274 are electrically connected to the secondary windings 234-236, respectively. The three phase output lines 292, 294, 296 may be jointly connected at a floating neutral node N.

Each of the power cell units may be configured with a relatively low voltage standard. The power cell units are connected in series with one phase output line such that a medium voltage output can be generated for one output phase of the multi-phase load according to the serially connected power cell units with low voltage.

The AC power source 280 may be a three-phase AC power source for supplying the AC input power to the primary winding (i.e., primary winding 212, 222, or 232) of the input transformer for each output phase. Each of the foregoing windings may be star-connected or mesh-connected, in which the mesh-connected winding may include delta configurations, extended-delta configurations, zigzag-delta configurations, etc. However, the foregoing windings can be implemented with individual and different configurations (e.g., some have delta configurations and the others have zigzag-delta configurations) according to practical needs, and thus the configurations of the foregoing windings are not limited to those shown in FIG. 2.

In operation, each power cell unit may operate individually. In addition, the secondary windings 214-216 may be phase-shifted from one another, the secondary windings 224-226 may be phase-shifted from one another, and the secondary windings 234-236 may be phase-shifted from one another. In some embodiments, the foregoing secondary windings may be advanced in phase, delayed in phase, or un-shifted in phase, relative to the primary winding. For example, in operation, the secondary windings 214 may be un-shifted in phase relative to the primary winding 212, the secondary windings 215 may be advanced in phase by 20° relative to the primary winding 212, and the secondary windings 216 may be delayed in phase by 20° relative to the primary winding 212.

In other embodiments, each of the power cell units 252-254 has an in-phase power output corresponding to a first output phase (e.g., phase A) of the multi-phase load 290, each of the power cell units 262-264 has an in-phase power output corresponding to a second output phase (e.g., phase B) of the multi-phase load 290, and each of the power cell units 272-274 has an in-phase power output corresponding to a third output phase (e.g., phase C) of the multi-phase load 290.

In some embodiments, the power cell units 252-254 are configured for generating in-phase power outputs (e.g., the power outputs with the same phase A) to the multi-phase load 290, the power cell units 262-264 are configured for generating in-phase power outputs (e.g., the power outputs with the same phase B) to the multi-phase load 290, and the power cell units 272-274 are configured for generating in-phase power outputs (e.g., the power outputs with the same phase C) to the multi-phase load 290.

In some other embodiments, one of the power cell units 252-254 is configured for generating a first power output, one of the power cell units 262-264 is configured for generating a second power output, and one of the power cell units 272-274 is configured for generating a third power output, in which the first power output, the second power output and the third power output are out of phase. For example, the power cell unit 254 generates the first power output with phase A, the power cell unit 264 generates the second power output with phase B, the power cell unit 274 generates the third power output with phase C, and the first power output with phase A, the second power output and the third power output are out of phase with respect to one another (i.e., phase A, phase B, and phase C are different from one another).

In some embodiments, each power cell unit may include an input AC-to-DC rectifier, a smoothing filter, and an output DC-to-AC converter. The input AC-to-DC converter converts the three-phase AC power into DC power. The smoothing filter is connected between the input AC-to-DC rectifier and the output DC-to-AC converter, for reducing ripples of the DC power, in which the smoothing filter may be comprised of one capacitor or a capacitor bank including multiple capacitors. The output DC-to-AC converter may be a single-phase H-bridge semiconductor switch using power transistors such as IGBTs.

Therefore, when each phase power output to the multi-phase load 290 needs to be increased, only one or more power cell units need to be added for each phase output and secondary windings corresponding thereto need to be added to the input transformer, but there is no need for additional transformers. Thus, the number of secondary windings are largely reduced and less than that necessary when a system is manufactured with one transformer and therefore harmonics of input current can be less fluctuated between phases.

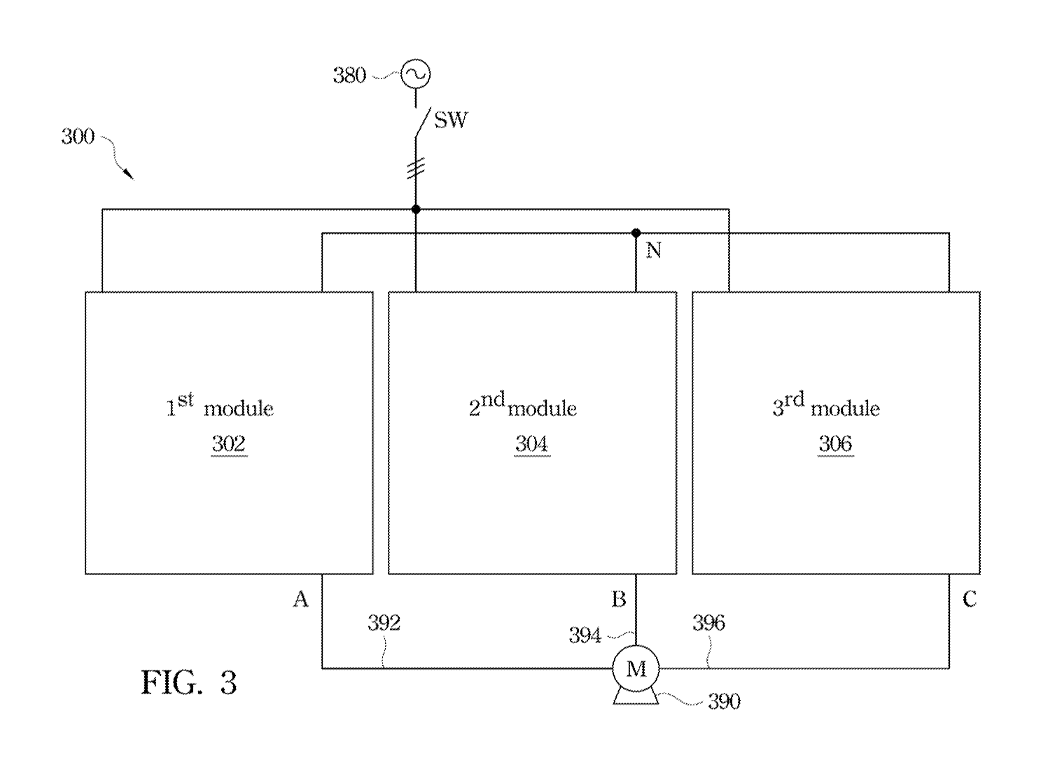

In other embodiments, the respective input transformer together with the corresponding power cell units may be modularized for each phase output. FIG. 3 is a diagram illustrating a power apparatus in accordance with another embodiment of the present invention. As shown in FIG. 3, the power apparatus 300 includes a first power module 302, a second power module 304, and a third power module 306, in which the first power module 302, the second power module 304 and the third power module 306 are configured for transforming a multi-phase input power from an AC power source 380 into out-of-phase power outputs (i.e., power outputs with different phases), respectively, through phase output lines 392, 394, 396 to a multi-phase load (e.g., three-phase AC motor) 390. The three phase output lines 392, 394, 396 may be jointly connected at a floating neutral node N.

In some embodiments, each of the power modules 302, 304, 306 is configured for transforming the multi-phase input power from the AC power source 380 into a single-phase power output to the multi-phase load 390.

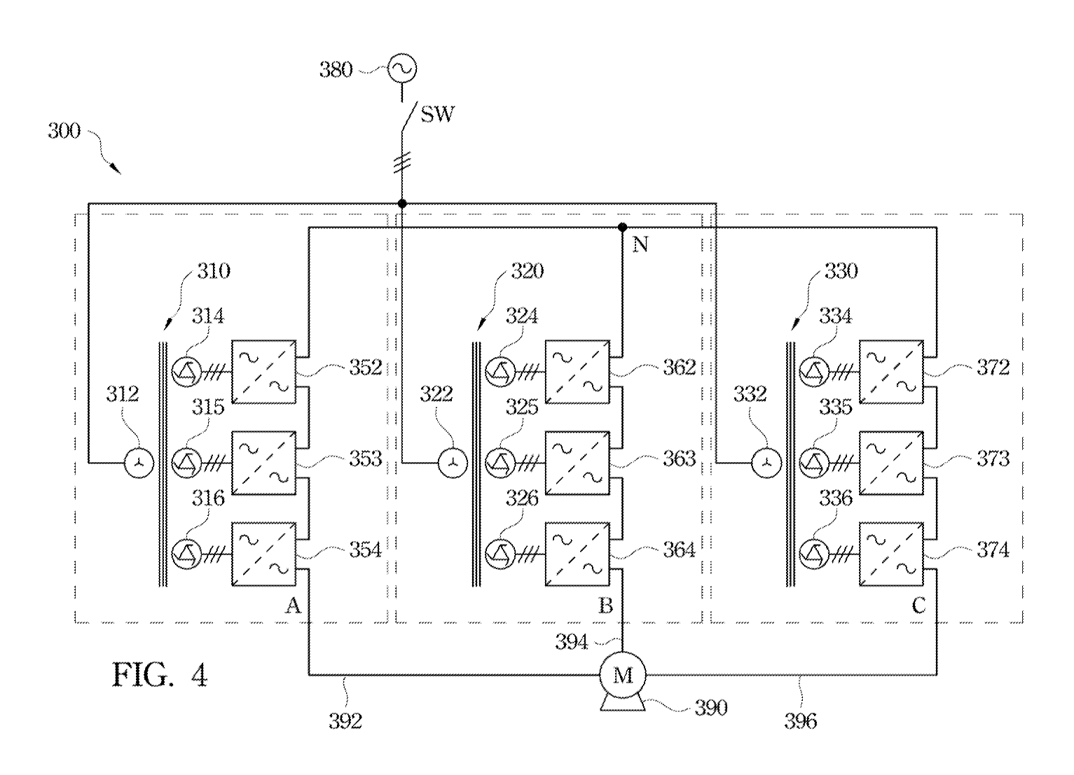

FIG. 4 is a diagram illustrating the power apparatus shown in FIG. 3 in accordance with one embodiment of the present invention. As shown in FIG. 4, each of the power modules 302, 304, 306 includes an input transformer and a plurality of power cell units connected with the input transformer.

Specifically, the power module 302 includes an input transformer 310 and power cell units 352-354, in which the power module 302 has at least one primary winding 312 and secondary windings 314-316. The primary winding 312 is electrically connected to the AC power source 380, for example, through a switch SW, and configured for receiving the multi-phase input power from the AC power source 380. The secondary windings 314-316 are configured for generating three-phase AC Power outputs, respectively. The power cell units 352-354 are connected in series with the phase output line 392 to the multi-phase load 390, in which the power cell units 352-354 are electrically connected to the secondary windings 314-316, respectively, and configured for converting the three-phase AC power outputs from the secondary windings 314-316 into in-phase (or single-phase) power outputs to the multi-phase load 390, respectively. Each of the power cell units 352-354 has an in-phase power output corresponding to a first output phase (e.g., phase A) of the multi-phase load 390.

The power module 304 includes an input transformer 320 and power cell units 362-364, in which the power module 304 has at least one primary winding 322 and secondary windings 324-326. The primary winding 322 is electrically connected to the AC power source 380, for example, through the switch SW, and configured for receiving the multi-phase input power from the AC power source 380. The secondary windings 324-326 are configured for generating three-phase AC power outputs, respectively. The power cell units 362-364 are connected in series with the phase output line 394 to the multi-phase load 390, in which the power cell units 362-364 are electrically connected to the secondary windings 324-326, respectively, and configured for converting the three-phase AC power outputs from the secondary windings 324-326 into in-phase (or single-phase) power outputs to the multi-phase load 390, respectively. Each of the power cell units 362-364 has an in-phase power output corresponding to a second output phase (e.g., phase B) of the multi-phase load 390.

The power module 306 includes an input transformer 330 and power cell units 372-374, in which the power module 306 has at least one primary winding 332 and secondary windings 334-336. The primary winding 332 is electrically connected to the AC power source 380, for example, through the switch SW, and configured for receiving the multi-phase input power from the AC power source 380. The secondary windings 334-336 are configured for generating three-phase AC power outputs, respectively. The power cell units 372-374 are connected in series with the phase output line 396 to the multi-phase load 390, in which the power cell units 372-374 are electrically connected to the secondary windings 334-336, respectively, and configured for converting the three-phase AC power outputs from the secondary windings 334-336 into in-phase (or single-phase) power outputs to the multi-phase load 390, respectively. Each of the power cell units 372-374 has an in-phase power output corresponding to a third output phase (e.g., phase C) of the multi-phase load 390.

Each of the power cell units may be configured with a relatively low voltage standard. The power cell units are connected in series with one phase output line such that a medium voltage output can be generated for one output phase of the multi-phase load according to the serially connected power cell units with low voltage.

In some embodiments, the input transformer 310, the input transformer 320, and the input transformer 330 are individual power transformers, and they may be the same or different from one another.

In other embodiments, each power cell unit may include an input AC-to-DC rectifier, a smoothing filter, and an output DC-to-AC converter. The input AC-to-DC converter converts the three-phase AC power into DC power. The smoothing filter is connected between the input AC-to-DC rectifier and the output DC-to-AC converter, for reducing ripples of the DC power, in which the smoothing filter may be comprised of one capacitor or a capacitor bank including multiple capacitors. The output DC-to-AC converter may be a single-phase H-bridge semiconductor switch using power transistors such as IGBTs.

In operation, each power cell unit may operate individually. In addition, the secondary windings 314-316 may be phase-shifted from one another by a phase angle, the secondary windings 324-326 may be phase-shifted from one another by a phase angle, and the secondary windings 334-336 may be phase-shifted from one another by a phase angle. In some embodiments, the foregoing secondary windings may be advanced in phase, delayed in phase, or un-shifted in phase, relative to the primary winding. For example, the secondary windings 314 may be un-shifted in phase relative to the primary winding 312, the secondary windings 315 may be advanced in phase by 20° relative to the primary winding 312, and the secondary windings 316 may be delayed in phase by 20° relative to the primary winding 312.

In some embodiments, each of the power modules 302, 304, 306 is configured for transforming the multi-phase input power from the AC power source 380 into a single-phase power output to the multi-phase load 390.

Therefore, when each phase power output to the multi-phase load 390 needs to be increased, only one or more power cell units need to be added for each phase output and secondary windings corresponding thereto need to be added to the input transformer, and additional transformers can be saved. Thus, the number of secondary windings are largely reduced and less than that necessary when a system is manufactured with only one transformer and harmonics of input current can be less fluctuated between phases.

For the foregoing embodiments, a simpler transformer configuration is provided to improve thermal management of each separate transformer unit, and the secondary winding structure is significantly simplified, and particularly, each transformer needs one-third of windings as compared to the conventional structure. In addition, simpler transformer structure leads to lower cost of manufacturing, while a higher number of transformer units reduce overall prices due to higher economy of scale. Moreover, the modular phase approach simplifies the cabling between the secondary windings and the power cell units by shortening cables lengths and facilitating connections during installation. The entire phase can be modularized and built in the same cabinet including the individual transformer or transformer unit.

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded with the broadest interpretation so as to encompass all such modifications and similar structures.

What is claimed is:

1. A power apparatus comprising:
a plurality of power modules, each of the power modules comprising:
an input transformer having at least one primary winding and a plurality of secondary windings, the primary winding being electrically connected to an AC power source; and
a plurality of power cell units connected in series with one phase output line to a multi-phase load, wherein the power cell units are electrically connected to the secondary windings, respectively.

2. The power apparatus as claimed in claim 1, wherein each of the power modules is configured for transforming a multi-phase input power from the AC power source into a single-phase power output to the multi-phase load.

3. The power apparatus as claimed in claim 1, wherein each of the power cell units is configured for converting a three-phase AC power output from the respective secondary winding into a single-phase power output.

4. The power apparatus as claimed in claim 1, wherein each of the power cell units has an in-phase power output corresponding to one output phase of the multi-phase load.

5. The power apparatus as claimed in claim 1, wherein the secondary windings are phase-shifted from one another by a phase angle.

6. The power apparatus as claimed in claim 1, wherein the secondary windings are advanced in phase, delayed in phase, and un-shifted in phase, respectively, relative to the primary winding.

7. The power apparatus as claimed in claim 1, wherein the input transformer is an individual power transformer.

8. A power apparatus comprising:
a plurality of power modules configured for transforming a multi-phase input power into out-of-phase power outputs, respectively, to a multi-phase load, each of the power modules comprising:
an input transformer having at least one primary winding and a plurality of secondary windings, the primary winding configured for receiving the multi-phase input power, the secondary windings configured for generating three-phase AC power outputs, respectively; and
a plurality of power cell units connected in series with one phase output line to the multi-phase load, wherein the power cell units are configured for converting the three-phase AC power outputs from the secondary windings into in-phase power outputs to the multi-phase load, respectively.

9. The power apparatus as claimed in claim 8, wherein the secondary windings are phase-shifted from one another by a phase angle.

10. The power apparatus as claimed in claim 8, wherein the secondary windings are advanced in phase, delayed in phase, and un-shifted in phase, respectively, relative to the primary winding.

11. The power apparatus as claimed in claim 8, wherein the input transformer is an individual power transformer.

12. A power apparatus comprising:
a first input transformer having at least one first primary winding and a plurality of first secondary windings, the first primary winding being electrically connected to an AC power source;
a plurality of first power cell units connected in series with a first phase output line to a multi-phase load, wherein the first power cell units are electrically connected to the first secondary windings, respectively;
a second input transformer having at least one second primary winding and a plurality of second secondary windings, the second primary winding being electrically connected to the AC power source;
a plurality of second power cell units connected in series with a second phase output line to the multi-phase load, wherein the second power cell units are electrically connected to the second secondary windings, respectively;
a third input transformer having at least one third primary winding and a plurality of third secondary windings, the third primary winding being electrically connected to the AC power source; and
a plurality of third power cell units connected in series with a third phase output line to the multi-phase load, wherein the third power cell units are electrically connected to the third secondary windings, respectively.

13. The power drive as claimed in claim 12, wherein each of the first power cell units has a first in-phase power output corresponding to a first output phase of the multi-phase load, each of the second power cell units has a second in-phase power output corresponding to a second output phase of the multi-phase load, and each of the third power cell units has a third in-phase power output corresponding to a third output phase of the multi-phase load.

14. The power apparatus as claimed in claim 12, wherein the first secondary windings are phase-shifted from one another, the second secondary windings are phase-shifted from one another, and the third secondary windings are phase-shifted from one another.

15. The power apparatus as claimed in claim 12, wherein one of the first power cell units is configured for generating a first power output, one of the second power cell units is configured for generating a second power output, one of the third power cell units is configured for generating a third power output, wherein the first power output, the second power output and the third power output are out of phase.

16. The power apparatus as claimed in claim 12, wherein the first power cell units, the second power cell units, or the third power cell units are configured for generating in-phase power outputs to the multi-phase load.

17. The power apparatus as claimed in claim 12, wherein the first input transformer, the second input transformer, and the third input transformer are individual.
